(19) United States
(12) Patent Application Publication
(10) Pub. No.: US 2020/0278290 A1
(43) Pub. Date: Sep. 3, 2020

(54) TABLET MEASURING APPARATUS AND TABLET MEASURING METHOD

(71) Applicant: Freund Corporation, Tokyo (JP)

(72) Inventors: Kiyoshi IMAI, Tokyo (JP); Shigemi ISOBE, Tokyo (JP); Takuya NAKAMURA, Tokyo (JP); Hayato MISONO, Tokyo (JP); Masaki TAKEUCHI, Tokyo (JP); Shohei YAMADA, Tokyo (JP)

(21) Appl. No.: 16/753,141

(22) PCT Filed: Nov. 6, 2018
(86) PCT No.: PCT/JP2018/041091

§ 371 Date: Apr. 2, 2020

(30) Foreign Application Priority Data
Nov. 20, 2017 (JP) 2017-222919

(51) Int. Cl. G01N 21/3563; G01N 21/85; A61J 3/00

(52) U.S. Cl. CPC G01N 21/3563; G01N 2021/8592; A61J 3/005; G01N 21/85

(57) ABSTRACT

A tablet measuring apparatus has a stainless steel housing, which contains a measuring section having a conveyance disk and an optical sensor, a tablet feeding section for feeding a tablet to the measuring section, and a recovery section for returning the tablet having undergone a measurement process to a tablet coating apparatus. The optical sensor can be adjusted in its height position by a height adjusting mechanism so that the optical sensor and the tablet can be separated from each other at a predetermined distance. The tablet is sucked to and conveyed by the conveyance disk and, during the conveyance, physical properties of the tablet are measured in a non-contact manner by the optical sensor. Out-of-spec tablets are discharged from a defective product discharging section, while in-spec tablets are fed back to the tablet coating apparatus through the recovery section.

### TECHNICAL FIELD

The present invention relates to a tablet measurement technique for measuring physical properties of tablets, including the film thickness, contents of active ingredients and the like and, more particularly, to a tablet measuring apparatus and a tablet measuring method for measuring physical properties of tablets using an optical sensor.

### BACKGROUND ART

In the manufacture of pharmaceutical products, in recent years, process analytical technology (PAT) is becoming increasingly important in view of the manufacture of tablets of stable physical properties. While, for example, various functions such as masking and enteric properties are imparted with a tablet by coating a film on its surface, film thickness control of a coated film may be needed as one of the steps in the process analysis. As a solution to the need, heretofore, there has been known a technique of controlling the coating thicknesses of tablets, including the step of sampling a fixed number of tablets during or after coating process and calculating the film thickness of each tablet from the weight difference between the film-coated tablet and the uncoated tablet. There has also been known a technique of using a measuring apparatus which uses an optical sensor such as a near-infrared (NIR) sensor to measure tablets on a one-by-one basis. Further, as described in Patent Document 2, attempts have been made to provide a light-transmitting member at a part of a tablet coating apparatus and to use a sensor to perform measurements of tablets during coating process by way of the light-transmitting member.

### CITATION LIST

### Patent Document

Patent Document 1: JP 2013-096717A

Patent Document 2: JP 2011-136311A

Patent Document 3: JP 2017-038908A

### DISCLOSURE OF THE INVENTION

### Problems to be Solved by the Invention

However, since the technique of using weight difference of tablets between before and after the coating process does not take measurements of tablets on an individual basis, it may pose lack in accuracy as a film thickness control scheme. On the other hand, the method of using an optical sensor, which is capable of individual-based tablet measurement, can output accurate measurements, but requires complex operations and hence is inefficient. Further, the system where a light-transmitting member is provided in a part of a tablet coating apparatus can manage real-time measurement; however, in the system, the distance between the tablet surface and the sensor is not constant, and besides, each tablet poses differently. For the above reasons, the system providing a light-transmitting member does not always give reliable measurement results.

### Means for Solving the Problems

A tablet measuring apparatus according to the present invention is a tablet measuring apparatus for measuring physical properties of a tablet ejected from a tablet coating apparatus, characterized by comprising: a tablet receiving section to which a tablet is introduced; a measuring section for measuring physical properties of the tablet while conveying the tablet; a tablet feeding section for feeding the tablet introduced to the tablet receiving section to the measuring section; and a recovery section for returning the tablet whose physical properties have been measured to the tablet coating apparatus. The measuring section has an optical sensor capable of measuring the physical properties of the tablet in a non-contact manner.

In the present invention, the tablet receiving section receives a tablet from the tablet coating apparatus and the tablet feeding section passes the tablet over to the measuring section. The tablet delivered to the measuring section is concurrently conveyed and measured in terms of physical properties thereof. The tablet having undergone the measurement is fed back from the recovery section to the tablet coating apparatus. The tablet measuring apparatus so configured as described above enables to can sequentially take accurate physical property measurements of each tablet, to grasp the coating thickness and the like of the tablet precisely on a real-time basis, and to achieve improvement in product quality.

In the tablet measuring apparatus of the invention, the measuring section may include a sensor positioning mechanism capable of adjusting the distance between the optical sensor and the tablet. Thereby, the optical sensor can be adjusted to the best position suited for every individual tablet to be measured. Therefore, measurement can be carried out while keeping the distance from each individual tablet constant at all times, which enables to conduct reliable physical property measurements. Further, an NIR sensor can satisfactorily serve as the optical sensor.

Further, the measuring section may include a conveying unit that sucks/supports the tablet while conveying the tablet. In that case, as the conveying unit, a conveyance disk can be used, which has sucking portions formed circumferentially at its end face so as to suck the side face of the tablet, whereby the conveyance disk-can suck/support the side face of the tablet in such a way that the front and back faces of the tablet are fully exposed. It is also possible to employ a belt conveyor which conveys the tablet being sucked to it.

Meanwhile, the tablet measuring method of the present invention is a tablet measuring method for measuring physical properties of a tablet ejected from a tablet coating apparatus. This method is configured to convey the tablet and, at the same time, measure the absorbance of the tablet using an optical sensor, calculate physical properties of the tablet from calibration curves concerning the physical properties and the measured value of absorbance, and return the tablet having undergone the measurement to the tablet coating apparatus.

In the present invention, while the tablet is being conveyed, the absorbance of a tablet is measured by the optical sensor and physical properties of the tablet is calculated from calibration curves concerning the physical properties and the measured value of absorbance. This configuration makes it possible to sequentially take accurate physical property measurements of each tablet, grasp the coating thickness and the like of the tablet correctly on a real-time basis, and achieve improvement in product quality.

In the tablet measuring method, the calculation of physical properties may be executed under the condition of the tablet being hermetically sealed off from the exterior environment. In general, the sampling process in the physical property measurement of tablets makes it possible to acquire various data at that moment; however, the conditions of the tablets cannot be grasped sequentially in real time. Further, the sampling operation is not considered to be beneficial if the apparatus is adapted for containment system (seal-off of workpiece) to prevent cross-contamination and operators' radiation exposure. In contrast, the tablet measuring apparatus and method of the present invention can perform containment-based physical property measurements, preventing product cross-contamination and operators' radiation exposure from occurring.

### Advantageous Effects of the Invention

The tablet measuring apparatus of the present invention includes a tablet receiving section to which a tablet is introduced, a measuring section for measuring physical properties of the tablet while conveying the tablet, a tablet feeding section for feeding the tablet introduced to the tablet receiving section to the measuring section, and a recovery section for returning the tablet whose physical properties have been measured to the tablet coating apparatus. This configuration makes it possible to sequentially take accurate physical property measurements of each tablet and hence grasp the coating thickness and the like of the tablet precisely on a real-time basis.

The tablet measuring method of the present invention is configured to convey a tablet and, at the same time, measure the absorbance of the tablet using an optical sensor, and calculate physical properties of the tablet from calibration curves concerning the physical properties and the measured value of absorbance. This configuration makes it possible to sequentially take accurate physical property measurements of each tablet, and hence grasp the coating thickness and the like of the tablet correctly on a real-time basis.

### BRIEF DESCRIPTION OF THE DRAWINGS

FIG. 1 is an explanatory view illustrating the outer appearance of a tablet measuring apparatus according to an embodiment of the present invention;

FIG. 2 is an explanatory view illustrating the internal configuration of the tablet measuring apparatus illustrated in FIGS. 1; and

FIG. 3 is an explanatory view illustrating a modification of the tablet measuring apparatus, where a tablet feed disk is provided as a tablet posture control unit between a measuring section and a tablet feeding section.

### MODE FOR CARRYING OUT THE INVENTION

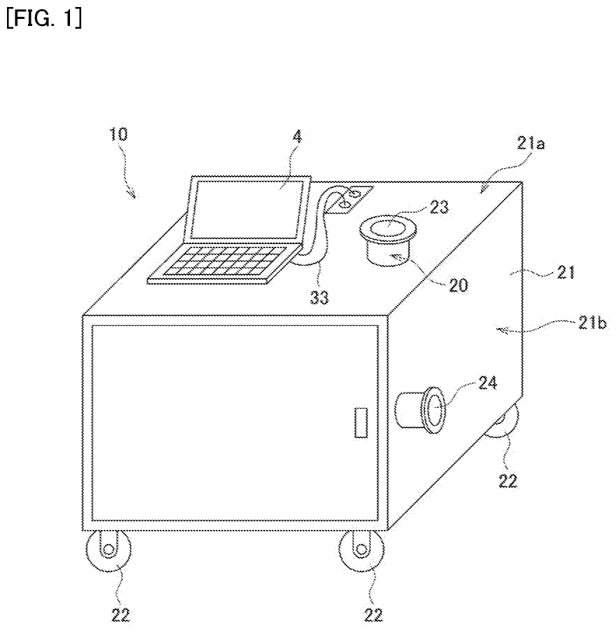

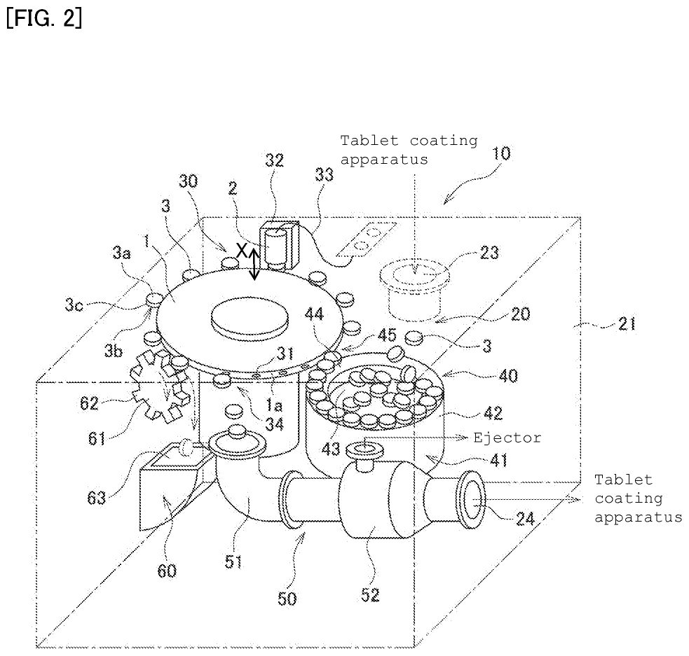

Hereinafter, an embodiment of the present invention will be described. The embodiment described below aims to provide a tablet measuring apparatus and a tablet measuring method that can sequentially take accurate measurements of physical properties of individual tablets using an optical sensor. FIG. 1 is an explanatory view illustrating the outer appearance of a tablet measuring apparatus 10 according to an embodiment of the present invention. FIG. 2 is an explanatory view illustrating the internal configuration of the tablet measuring apparatus 10. The tablet measuring method according to the present invention is implemented by the tablet measuring apparatus 10 illustrated in FIG. 1. The tablet measuring apparatus 10 is connected to a tablet coating apparatus (hereinafter abbreviated as “coating apparatus”) and performs a real-time measurement on the film-coating thickness and the like (physical properties) of each tablet 3 ejected from the coating apparatus.

As shown in FIGS. 1 and 2, the tablet measuring apparatus 10 has a housing 21 made of stainless steel, accommodating a measuring section 30 equipped with a conveyance disk 1 and an optical sensor 2, a tablet feeding section 40 for feeding the tablets 3 to the measuring section 30, and a recovery section 50 for returning the tablets 3 that have been measured to the coating apparatus. In the tablet measuring apparatus 10, the measurement of physical properties of the tablets 3 is carried out in a condition where the tablets 3 are hermetically sealed off from outside of the apparatus (environmental containment). Therefore, the course of the tablets 3 physically traveling, namely the route from the coating apparatus to the tablet measuring apparatus 10, respective components including the measuring section 30 within the tablet measuring apparatus 10 and the route from the tablet measuring apparatus 10 to the coating apparatus are all hermetically sealed off from the exterior environment in the airproof condition.

On the housing 21, a computer (PC) 4 is disposed as control/measurement equipment. The computer 4 controls over the operation of the tablet measuring apparatus 10, fetches physical property data of each tablet 3 in real time from the optical sensor 2, and displays the fetched data as needed. Casters 22 are attached to the lower surface of the housing 21, so that the tablet measuring apparatus 10 can be moved according to the needs. A tablet charging port 23, as a tablet receiving section 20, is opened in an upper surface 21a of the housing 21. Any tablets 3 ejected from the coating apparatus are introduced into the tablet charging port 23. A tablet recovery port 24 of the recovery section 50 is opened in a side surface 21b of the housing 21.

The tablet feeding section 40 has a rotary feeder 41. Into the rotary feeder 41, the tablets 3 ejected from the not-shown coating apparatus are supplied through the tablet charging port 23. A hopper may be provided between the tablet charging port 23 and the rotary feeder 41 to retain the tablets 3 therein and feed them to the rotary feeder 41. The tablets 3 fed to the rotary feeder 41 are passed over to the conveyance disk 1 of the measuring section 30. The conveyance disk 1 sucks the tablets 3 onto an end face la thereof and conveys them. Each tablet 3 being conveyed is measured by the optical sensor 2 in terms of the film-coating thickness and physical properties thereof including the contents of active ingredients. The measured data is sent to the computer 4. The measured tablet 3 is collected at the recovery section 50 arranged in the position following the measuring section 30 and fed back to the not-shown coating apparatus through the tablet recovery port 24.

In the tablet measuring apparatus 10, as illustrated in FIG. 2, firstly a sampled tablet 3 is fed to the tablet feeding section 40 through the tablet charging port 23. The rotary feeder 41 of the tablet feeding section 40 is a non-vibratory rotary parts feeder, and is constituted by coaxially forming a rotary disk 43 and an annular rotary plate 44 within a cylindrical casing 42. The tablet 3 is fed through the tablet charging port 23 onto the rotary disk 43 while rotating. The tablet 3 on the rotary disk 43 moves in the circumferential direction by the rotation of the disk 44, moving toward the annular rotary plate 44. The tablet 3 on the annular rotary plate 44 then moves in the circumferential direction by the rotation of the rotary plate 44 so as to be delivered to a tablet acquiring part 45. The tablet 3 delivered to the tablet acquiring part 45 is sucked onto the rotating conveyance disk 1 of the measuring section 30.

The end face la of the conveyance disk 1 has suction holes (sucking portions) 31 connected with a suction device (not shown) such as a vacuum pump. A side face 3c of the tablet 3 is sucked to the suction hole 31 and hence the tablet 3 is held on to the end face la of the conveyance disk 1. The tablet 3 is sucked to the end face la in a horizontal posture (that is, a state of a front face 3a and a back face 3b of the tablet 3 facing upward and downward in a perpendicular direction, respectively), and is conveyed in the circumferential direction without changing the posture, as rotation of the conveyance disk 1.

Due to the rotation of the conveyance disk 1, the tablet 3 sucked to the conveyance disk 1 is conveyed to the position of optical sensor 2 while keeping the horizontal posture, where physical properties of the tablet 3 such as the film-coating thickness and contents of active ingredients are measured. The optical sensor 2 is a NIR sensor that uses near-infrared rays as inspection light and takes the measurements of physical properties of the tablet 3 non-destructively in real time. The optical sensor 2 irradiates a near-infrared ray in a prescribed wavelength region (for example, about 800-3000 nm) and receives a light reflected from the tablet 3. The data of the reflective light is sent to the computer 4, where chemical properties of the tablet 3 such as the absorbance and transmittance of light are calculated. In the computer 4, calibration curves concerning physical properties of the tablet 3, including the absorbance, is stored in advance. The computer 4 calculates physical properties of the tablet 3 such as the film-coating thickness thereof, from the calibration curves and the measured values of e.g., absorbance. Alternatively, it is also possible that the optical sensor measures the surface of a tablet which is yet to be coated (uncoated tablet) and the data of reflected light on the tablet surface is stored in advance in the computer. Then, the data thus stored is compared with the data of reflected light measured by the optical sensor on the surface of the tablet having gone through the coating process, and through this comparison, the film-coating thickness of the tablet 3 can be predicted.

The tablet measuring apparatus 10 is provided with a height adjusting mechanism (sensor positioning mechanism) 32 which makes the height level of the optical sensor 2 adjustable in accordance with the thickness of the tablet 3 so that physical properties of various types of tablets 3 can be precisely measured. The height adjusting mechanism 32 causes the optical sensor 2 to move along X-direction (the direction perpendicular to the surfaces of the tablet) as indicated in FIG. 2, whereby the height level of the optical sensor 2 can be adjusted in accordance with the size of the tablet 3. The height adjusting mechanism 32 is, e.g., comprised of a not-shown motor and a not-shown ball screw, and detects the height level of the optical sensor 2 using a position sensor including a rotary encoder or potentiometer. The data detected by the position sensor is sent to the computer 4, where the distance between the optical sensor 2 and the tablet 3 is feedback controlled so as to take a desired value. This arrangement allows the distance between the table 3 and the optical sensor 2 to be held constant, independent of size variation of the tablet 3. This makes it possible to perform the physical property measurement of different types of the tablets 3 under the best suited condition and hence to obtain measured data which is accurate and highly reliable. The optical sensor 2 shown in FIG. 2 is placed above the horizontal surface of the conveyance disk to measure the upper surface of the tablet, although the optical sensor 2 may be placed below the horizontal surface of the conveyance disk to measure the lower surface of the tablet. The placement of the optical sensor above the conveyance disk can facilitate the maintenance in case of trouble, whereas the placement below the conveyance disk can make the housing compact.

In the tablet measuring apparatus 10, the tablet 3 is fully exposed to the optical sensor 2 with the front face 3a or back face 3b thereof positioned vis-à-vis the optical sensor 2. The apparatus 10, therefore, can thoroughly measure the entire surface of the tablet 3, allowing every corner of the tablet region to be measurable without fail. Therefore, in this respect as well, accurate and highly reliable measured data concerning the tablet 3 can be obtained. While FIGS. 1 and 2 illustrate a configuration where the optical sensor 2 and the computer 4 are connected by a connection cable 33, they can be connected by a wireless communication unit.

The tablet 3 whose physical properties have been measured by the optical sensor 2 is sent to the recovery section 50 arranged in a position following the measuring section 30. In a position preceding the recovery section 50, a defective product discharging section 60 is provided so as to eliminate the tablets 3 which are determined to be off-spec products (defective products) as a result of physical property measurement. In the defective product discharging section 60, an excluder 61 is provided so as to remove defective products from the conveyance disk 1. The excluder 61 is formed like a gear having a plurality of engaging projections 62 radially extending on the circumference thereof. Once a tablet 3 determined to be an out-of-spec product in terms of film-coating thickness or the like arrives at the defective product discharging section 60, the excluder 61 starts rotating, causing the tablet 3 to fall off the conveyance disk 1 by the engaging projection 62. The tablet 3 that fell off the conveyance disk 1 is excluded from the production line, while the tablet 3 which is non-defective is sent to the recovery section 50.

The tablet 3 determined to be within the scope of a standard (non-defective product) is conveyed to a tablet dislodging part 34, where the tablet 3 is released from the sucked state. Namely, the sucking action of the suction hole 31 is stopped, and hence the tablet 3 breaks away from the end face la of the conveyance disk 1. The tablet 3 separated from the conveyance disk 1 is held within a recovery pipe 51 of the recovery section 50. The recovery section 50 has a main body 52 connected with a not-shown ejector. The upstream side of the main body 52 is linked to the recovery pipe 51 and the downstream side thereof to the tablet recovery port 24. The tablet 3 at the tablet dislodging part 34 is attracted to and sucked into the recovery pipe 51 and runs through the main body 52 to reach the tablet recovery port 24. The tablet 3 having been brought to the tablet recovery port 24 is then returned to the coating apparatus by way of a not-shown conduit.

As described above, the tablet measuring apparatus 10 of the present invention uses the conveyance disk 1 to suck the tablets 3, arranging the respective tablets 3 in a coordinated manner to send them to the measuring section 30. At the measuring section 30, the optical sensor 2 measures physical properties of each tablet 3 in a non-contact manner. At this time, the height adjusting mechanism 32 adjusts the position of the optical sensor 2 to the optimum height level that meets the size of the tablet, before the execution of the measurement. Accordingly, in the tablet measuring apparatus 10, the entire surface of the tablet 3 can be measured at an equal distance constantly, which enables to make a reliable physical property measurement. In consequence, it is possible to sequentially and accurately measure the physical properties of each tablet, grasping the accurate film-coating thickness and the like of the tablet in real time, and hence improve the product quality.

Further, with respect to the tablets 3 measured in terms of physical properties, any defective products are eliminated at the defective product discharging section 60 and any non-defective products are returned from the recovery section 50 to the coating apparatus. Thus, the defective products are removed without fail, while the non-defective products are promptly returned to the processing apparatus. The tablet measuring apparatus 10 of the present invention is designed to perform speedy inspections of tablets and, therefore, it is possible to subject all of the tablets to inspection as well as picking up some of the tablets in process as samples for physical property measurement. Hence, the product quality can more reliably be improved without increasing the process time and the number of processes.

The present invention is by no means limited to the above embodiment and can be modified in various ways without departing from the scope of the invention.

In the above embodiment, for example, the processing target of the tablet measuring apparatus 10 is a circular tablet; however, the tablet measuring apparatus of the present invention can process various types of tablets such as oblong tablets, caplets and polygon-shaped tablets. Further, while, in the above embodiment, the non-vibratory rotary feeder 41 is arranged in the tablet feeding section 40, a vibratory rotary feeder can also be applied. Further, the height adjusting mechanism 32 can take any alternative configuration other than the configuration of motor and ball screw; for instance, it is possible to adopt a pneumatic actuator or hydraulic actuator as the drive source, and a rack-and-pinion system as the power transmission mechanism. Note that not only the above-described rotary motor but also a linear motor is applicable as a motor. Moreover, for the optical sensor to be employed in the above-described 100% inspection, Raman scattered light or THz (terahertz) waves can be used in place of NIR.

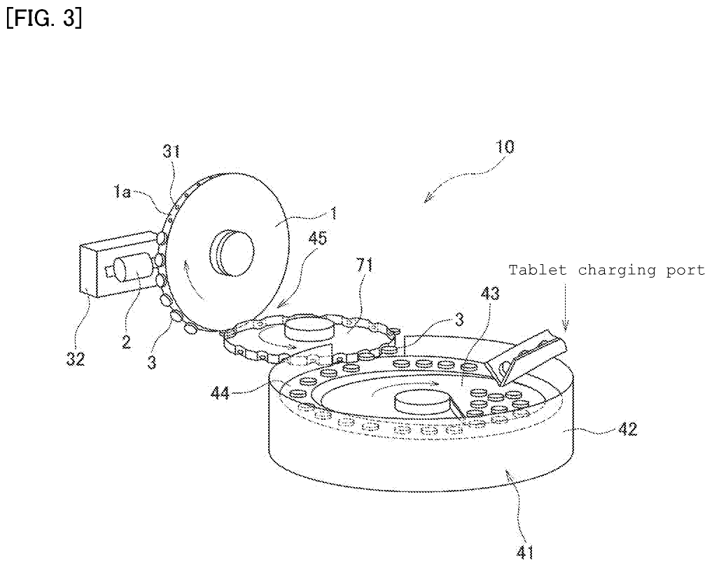

Additionally, although the conveyance disk 1 is used to suck/convey the tablets 3 in the measuring section 30, the conveyance unit for the tablets is not limited to this, and may be a conveyance unit using belt-conveyor system with suction holes which function to suck tablets during conveyance. Also, as illustrated in FIG. 3, as a tablet posture control unit, a tablet feeding disk 71 for sucking/conveying the tablets 3 may be provided between the conveyance disk 1 and the rotary feeder 41. This configuration allows the tablets 3 to be sucked to the conveyance disk 1 while keeping its posture more stable.

### INDUSTRIAL APPLICABILITY

The present invention is applicable not only to pharmaceutical tablets, but also to food products such as confectionary having a tablet shape.

### REFERENCE SIGNS LIST

1: Conveyance disk (conveyance unit)
1a: End face
2: Optical sensor
3: Tablet
3a: Front face
3b: Back face
3c: Side face
4: Computer
10: Tablet measuring apparatus
20: Tablet receiving section
21: Housing
21a: Upper face
21b: Side face
22: Caster
23: Tablet charging port
24: Tablet recovery port
30: Measuring section
31: Suction hole
32: Height adjusting mechanism (sensor positioning mechanism)
33: Connection cable
34: Tablet dislodging part
40: Tablet feeding section
41: Rotary feeder
42: Casing
43: Rotary disk
44: Annular rotary plate
45: Tablet acquiring part
50: Recovery section
51: Recovery pipe
52: Main body
60: Defective product discharging section
61: Excluder
62: Engaging projection
63: Defective product discharge port
71: Tablet feeding disk

1. A tablet measuring apparatus for measuring the physical properties of a tablet ejected from a tablet coating apparatus, the tablet measuring apparatus comprising:
a tablet receiving section to which a tablet is introduced;
a measuring section for measuring physical properties of the tablet while conveying the tablet;
a tablet feeding section for feeding the tablet introduced to the tablet receiving section to the measuring section; and
a recovery section for returning the tablet whose physical properties have been measured to the tablet coating apparatus,
wherein the measuring section has an optical sensor capable of measuring the physical properties of the tablet in a non-contact manner.

2. The tablet measuring apparatus according to claim 1, wherein
the measuring section has a sensor positioning mechanism capable of adjusting the distance between the optical sensor and the tablet.

3. The tablet measuring apparatus according to claim 1, wherein
the optical sensor is an NIR sensor.

4. The tablet measuring apparatus according to claim 1, wherein
the measuring section includes a conveying unit configured to suck/support the tablet while conveying the tablet.

5. The tablet measuring apparatus according to claim 4, wherein
the conveying unit is a conveyance disk, and
the conveyance disk includes sucking portions formed at an end face thereof along the circumferential direction so as to suck the side face of the tablet, wherein the disk can suck/support the side face of the tablet in such a manner that the front and back faces of the tablet are fully exposed.

6. The tablet measuring apparatus according to claim 4, wherein
the conveyance unit is a belt conveyor configured to convey the tablet being sucked thereto.

7. A tablet measuring method for measuring physical properties of a tablet ejected from a tablet coating apparatus, comprising:
conveying the tablet and, at the same time, measuring the absorbance of the tablet using an optical sensor; and
calculating physical properties of the tablet from calibration curves concerning the physical properties and the measured value of absorbance, and returning the tablet after the measurement to the tablet coating apparatus.

8. The tablet measuring method according to claim 7, wherein
the calculation of the physical properties is carried out under the condition of the tablet being hermetically sealed off from the exterior environment.

9. The tablet measuring apparatus according to claim 2, wherein
the optical sensor is an NIR sensor.

10. The tablet measuring apparatus according to claim 2, wherein
the measuring section includes a conveying unit configured to suck/support the tablet while conveying the tablet.

11. The tablet measuring apparatus according to claim 3, wherein
the measuring section includes a conveying unit configured to suck/support the tablet while conveying the tablet.
